(19) United States
(12) Patent Application Publication
(10) Pub. No.: US 2009/0145628 A1
(43) Pub. Date: Jun. 11, 2009

(54) Method of using finely stranded 32-56 gauge "Litz Wire" in both the construction of the Megasonic amplifier (including but not limited to the power transformer and the output filter magnetics) and the interconnect cabling from the amplifier to the transducer, utilizing frequencies above 500kHz to 5 MHz and beyond, but not limited to these frequencies

(76) Inventors: Karl Gifford, Alpharetta, GA (US); Henry Miranda, Fremont, CA (US)

Correspondence Address: Mr. Karl Gifford, 10565 Wynbridge Drive, Alpharetta, GA, 30022, US

(21) Appl. No.: 11/999,492

(22) Filed: Dec. 5, 2007

(51) Int. Cl. H01B 7/00

(52) U.S. Cl. 174/113 R

(57) ABSTRACT

Utilizing Litz wire characteristics in the construction of Megasonic components achieves lower temperatures, higher operating efficiencies, and the ability to deliver more power at higher frequencies with less cooling.

### CROSS-REFERENCE TO RELATED APPLICATIONS

This application claims the benefit of provisional patent application Ser. No. 60/872,734, filed 2006 Dec. 4 by the present inventor, Karl Gifford of 10565 Wynbridge Drive, Alpharetta, Ga. 30022 and Co-inventor Henry Miranda of 44060 Old Warm Springs Blvd, Fremont, Calif. 94538.

### FEDERALLY SPONSORED RESEARCH

Not Applicable

### SEQUENCE LISTING OR PROGRAM

Not Applicable

### BACKGROUND

1. Field of Invention

This invention relates to the use of “Litz wire” in the construction of the Megasonic amplifier (signal source), and/or the interconnect cabling for high frequency ultrasonic systems (500 kHz and above) typically referred to in the semiconductor industry as “Megasonic Systems”.

2. Prior Art

The Megasonic System typically is comprised of 2 parts, a signal source, commonly referred to in the industry as the “amplifier” and the transducer, which is typically a piezo electric device used to create the acoustic pressure wave from the electrical signal supplied by the generator. Original frequencies for the Megasonic Systems were from 400 kHz to 750 kHz typically.

The electronics industry is the primary user of Megasonic Systems in the cleaning process used to make semiconductor devices, such as memory chips, microprocessors, and most other semiconductor devices. These semiconductor components are initially etched into wafers. Wafers are thin round silicon slices that are used as the substrate, upon which the actual semiconductor Integrated Circuits are fabricated. Over the years, the geometries (line and spaces), have continually reduced in size. The process is actually a photographic process where the desired patterns are exposed onto the surface of the wafers and then they are either etched or plated selectively based upon the pattern that the wafer was exposed with.

Particles that are on the surface of the wafer can cause defects in the images and actually ruin the integrated circuits, and as the lines and spaces get smaller then the acceptable size of the particle contamination has also become much smaller. Today, particles greater than 35 nanometers can cause serious problems and even device failure.

Conventional Megasonics that operated in the 750-900 KHz range needed the power to be increased to effectively clean the smaller particles; this is primarily because smaller particles are harder to remove. When the power was increased the acoustical energy actually started to damage to the devices that were being fabricated on the surface of the Wafer. It has become accepted that higher frequencies work better to remove the smaller particles without causing as much damage. Because of this, there is a migration toward 2, and 3 MHz Megasonic systems.

Generating and delivering the higher frequencies created several new problems. As the frequencies increased, the IR(current resistance) loss in the magnetics of the amplifier and the cabling became much more significant, primarily due to the “skin effect”. The “skin effect” is a phenomenon where the electrons are forced to the surface of the conductor in high frequency fields. The IR loss and skin effect in standard amplifier magnetics and cabling result in a significant increase in temperature and a decrease in operating efficiency.

Until now the way that previous amplifiers dealt with this problem was to simply add more cooling, or settle for lower power levels. Often times amplifiers would achieve less than 35% efficiency overall, especially at frequencies above 3 MHz with at least 300 watts of power.

The utilization of Litz wire in the construction of the magnetics and the cabling provides a significant increase in efficiency, and substantially lowers heat generation. With the use of the Litz wire in the Megasonic construction, it has been shown to achieve efficiencies above 90%.

Early amplifiers used solid wire, coarsely stranded wire (typically 32 strands or less), or tubing for construction of part of the transformers and magnetics used in the amplifier. In frequencies above 50 kHz it became desirable to use stranded wire in the construction of the magnetics. However no one used stranded Litz wire. The wire was simply stranded to increase the surface area. As the frequencies exceeded 1 MHz, the skin effect caused greater losses that required the Litz wire's unique properties.

### SUMMARY

The use of Litz wire in the fabrication of Megasonic system components increases efficiency, power density, and reduces size, weight, and heat loss in high frequency systems.

### DRAWINGS—TABLE/FIGURES/REFERENCE NUMERALS

Table 1—Litz Wire Benefits in the construction of the Megasonic Amplifier in comparison with Solid and Stranded Wire.

FIG. 1—Toroid Inductor wrapped 16 times with #14 gauge Litz wire.

Reference Numerals: Top Side View and Side View.

10—Toroid Inductor 12—Litz Wire

14—Fused Litz Wire with solder end connectors

FIG. 2—Power Transformer wrapped with Litz wire.

Reference Numerals: Side View and Top View.

20—Power Transformer 22—Litz Wire

24—Fused Litz Wire with solder end connectors

FIG. 3—Megasonic amplifier (including but not limited to the power transformer and the output filter magnetics) and the interconnect cabling from the amplifier to the transducer.

Reference Numerals:

30—Amplifier 31—Toroid Inductor

32—Power Transformer 33—Interconnect Cabling

34—Piezo Transducer

FIG. 4—Typical Output Section of Megasonic Amplifiers.

Reference Numerals:

40—Transformer 41—Primary Input

42—Secondary Output 43—Inductor

44—Litz Wire 45—Transducer

FIG. 5—Impedance Relationship of Wire Types and Piezo Load

Reference Numerals:

50—Piezo 52—Solid Wire

54—Stranded Wire 54—Litz Wire

### DETAILED DESCRIPTION—FIGS (1,2,3,4,5)

### Static Description of Figures

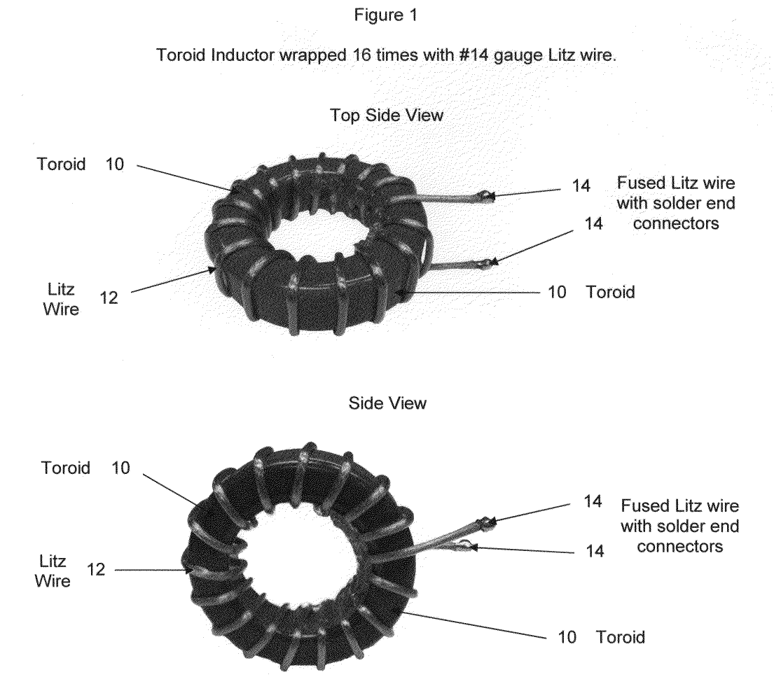

(FIG. 1) A typical implementation of this invention is to wind a toroid (10), with 16 turns of a #14 Litz wire (12). The Litz wire (12) is fixed in place, striped at the end, and then fused to form a solder connection point (14).

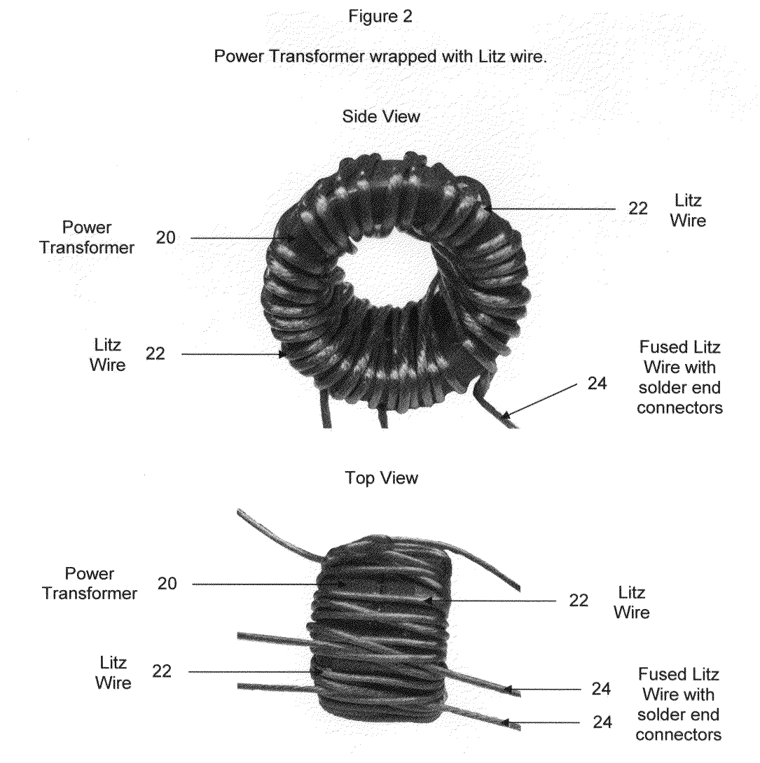

(FIG. 2) Another typical application is the construction of the power transformer (20), used to both isolate electrically the primary from the actual RF output and also to allow an impedance transformation. In this application, the Litz wire (22) is wrapped around a Toroid (20) or other magnetic core well suited for the desired operating frequency. The Litz wire (22) is fixed in place, striped at the end, and then fused to form a solder connection point (24).

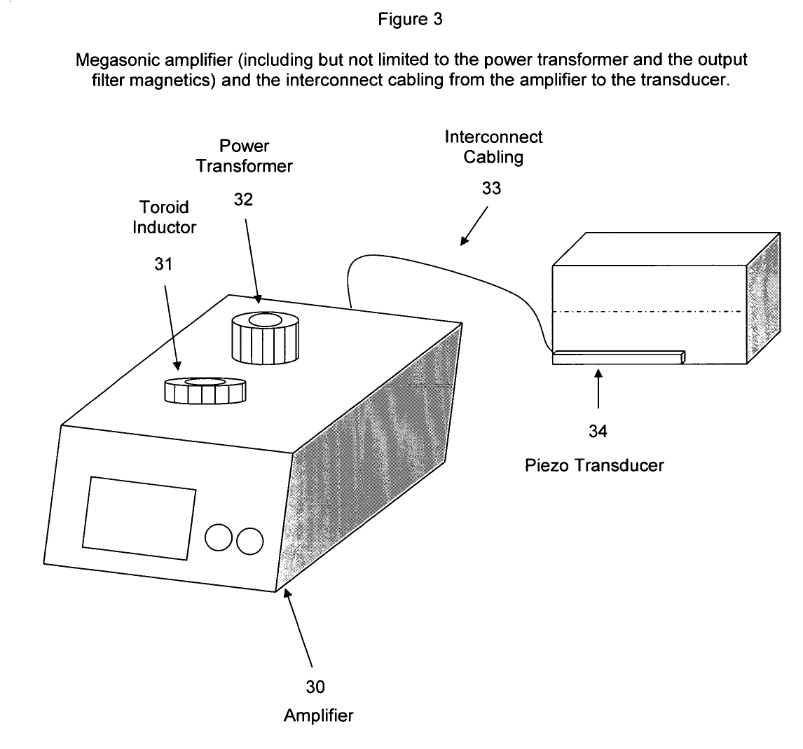

(FIG. 3) Another typical application is in the construction of the interconnect cabling (33) from the Megasonic amplifier (30) to the Piezo Transducer (34). The Litz wire is fixed in place, striped at the end, and then fused to form a solder connection point.

### Operation—FIGS. (1,2,3,4,5)

### Operational Description of Figures

Litz wire, as it is commonly referred to in the industry, consists of a single cable made up of hundreds of finely stranded wires, (typically 36 gauge to 60 gauge). Each of the finely stranded wires is coated with a thin insulation. These individual wires are then twisted together and then finally coated with an encompassing insulation. The unique property of the individually insulated, small diameter wires when used to construct a larger cable (typically 28 gauge and larger), allows for significant reduction in resistance loss at higher frequencies.

The reactive impedance of piezo electric transducers is complex, however one of the primary components to the impedance is the reactive capacitance. The formula for

Reactive capacitance is 1/2*Pi*F*C where;

Pi is 3.1412 . . .

F is the frequency.

C is the capacitance.

From this formula it is easily shown that the impedance drops as the frequency rises, and the skin effect is the opposite, which means the impedance mismatch gets greater as the frequency goes up, thus requiring much larger wire to achieve similar power levels; this unfortunately leads to significant heat generation.

The Litz wire's unique frequency/impedance/skin effect characteristics makes it the ideal choice for higher frequency amplifier magnetics and interconnect cabling. The implementation of the Litz wire is identical to previously utilized fabrication techniques used in building the amplifiers and interconnect cabling.

### Advantages and Benefits

The primary benefit is the low impedance at high frequencies exhibited by Litz wire in the construction of the Megasonic magnetics and the interconnect cabling. The following are benefits from using Litz Wire in the construction of the Megasonic system.

1. Reduce the Skin Effect.

2. Lower Impedance versus Frequency.

3. Lower Loss=Lower Operating Temperature.
a. Allows Higher Operating Efficiencies.
b. Allows more power per cubic inch.
c. Lower Cost per Watts.
d. Smaller Package
e. Higher Operating Power
f. Higher Operating Frequency
g. Significant Reduction in Heat

The items in (Table 1) provide an additional illustration of the Litz Wire Benefits in the construction of the Megasonic Amplifier in comparison with Solid and Stranded Wire.

The Drawing in (FIG. 1) identifies the features of the “Toroid Inductor wrapped 16 times with #14 gauge Litz wire”. Both FIG. 1's Top Side view and the Side view identifies the Toroid Inductor (10), the Litz Wire (12), and the Fused Litz wire with solder end connectors (14).

The Drawing in (FIG. 2) identifies the features of “The Power Transformer with Litz Wire”. Both FIG. 2 Top Side View and FIG. 2 Side View identifies the Power Transformer (20), the Litz Wire (22), and the Fused Litz wire with solder end connectors (24).

The Drawing in (FIG. 3) identifies the typical application of the “Megasonic amplifier (including but not limited to the power transformer and the output filter magnetics) and the interconnect cabling from the amplifier to the transducer”. The Amplifier (30) may include Toroid Inductor(s) (31), and Power Transformer(s) (32), which utilize Litz wire in their construction. The Interconnect Cabling (33) joins the Amplifier (30) to the Transducer (34).

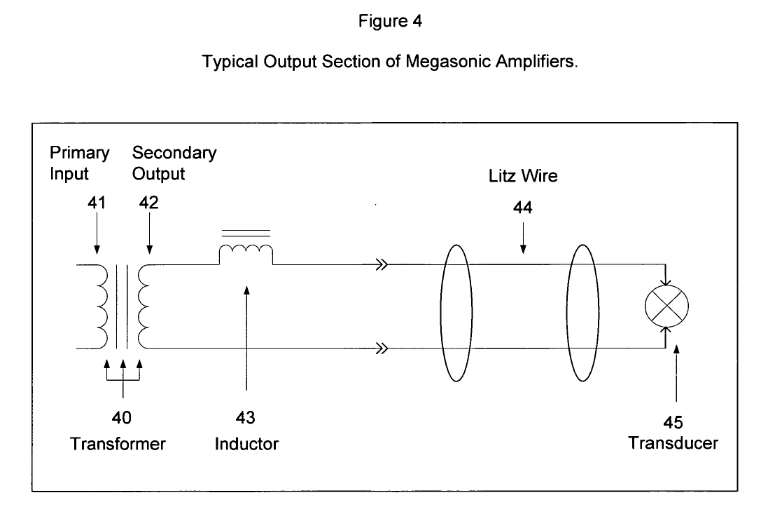

The diagram in (FIG. 4) “The Typical Output Section of the Megasonic Amplifier” identifies the electrical flow from the Transformer to the Piezo Electric Transducer. The Transformer (40) is divided into two items, the Primary Input (41) and the Secondary Output (42). The flow of current passes through the Toroid Inductor (43) and then connects with the Litz Wire (44). The Litz Wire (44) then connects directly to the Transducer (45).

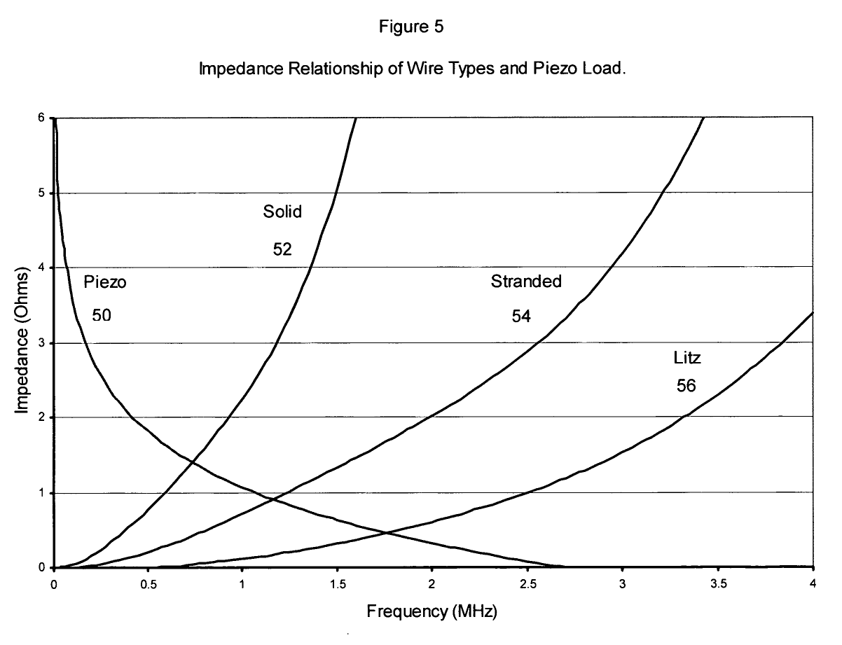

The Graph in (FIG. 5) compares, in general, the relationship between Impedance and Frequency for three different types of wires: Solid (50), Stranded (54), and Litz (56) and Piezo Electric Transducers (50). The impedance versus frequency rises faster in Solid Wire (52) and Stranded Wire (54) than it does in Litz Wire (56) in respect to Frequency.

Furthermore, in (FIG. 5), the Piezo's (50) impedance drops dramatically at higher frequencies. The relationship between the Litz Wire's (56) relatively lower impedance at higher frequencies and the Piezo's (50) lower impedance at higher frequencies makes the Litz Wire (56) the best choice in high frequency Megasonic systems.

### Conclusion, Ramifications, and Scope

The benefits of Litz wire in higher frequency Megasonic Systems allows for a competitive advantage over conventional wire. The use of the Litz wire in Megasonic systems will allow practical limits of operation to go beyond 5 megahertz, and this will help make advances in the semiconductor industry possible for years to come.

### Broadening Paragraph

Although the descriptions above contain many specificities, these should not be construed as limiting the scope of the embodiment but as merely providing illustrations of some of the typical embodiments.

Contact Information: 770-343-8716 Drawings (page 1 of 6)

TABLE 1
Litz Wire Benefits in the construction of the Megasonic Amplifier
in comparison with Solid and Stranded Wire.

| | Type of Wire | | |
|---|---|---|---|
| | Solid | Stranded | Litz |
| Lower Loss = | 300° Celsius | 135° C. to 165° C. | +10° Ambient |
| Lower Operating | | | |
| Temperature | | | |
| Allows Higher | <25% | <75% | >95% |
| Operating | | | |
| Efficiencies | | | |
| Smaller Package | 100% NP | 50% | 75% |
| Higher Operating | 100 Watts | 500 Watts | 2000 Watts |
| Power | | | |
| Heat Reduction | | | 80% |

1. In an amplifier used to generate a RF signal for the purpose of driving a piezo electric transducer at or above 500 kHz.

2. In the construction of magnetics used in the amplifier and impedance matching networks.

3. In the construction of the power transformer(s) in the amplifier to generate a frequency of 500 kHz or higher.

4. In the construction of an impedance matching network to be used either inside the amplifier or between the output of the amplifier and the transducer.

5. In the fabrication of cabling, connecting the amplifier to the piezo electric transducer.
